(19) United States
(12) Patent Application Publication
(10) Pub. No.: US 2012/0206442 A1
(43) Pub. Date: Aug. 16, 2012

(54) Method for Generating Virtual Images of Scenes Using Trellis Structures

(76) Inventors: Dong Tian, Boxborough, MA (US); Yongzhe Wang, Shanghai (CN); Anthony Vetro, Arlington, MA (US)

(21) Appl. No.: 13/307,936

(22) Filed: Nov. 30, 2011

Related U.S. Application Data
(63) Continuation-in-part of application No. 13/026,750, filed on Feb. 14, 2011.

(51) Int. Cl. G06T 15/00

(52) U.S. Cl. 345/419

(57) ABSTRACT

An image for a virtual view of a scene is generated based on a set of texture images and a corresponding set of depth images acquired of the scene. A set of candidate depth values associated with each pixel of a selected image is determined. For each candidate depth value, a cost that estimates a synthesis quality of the virtual image is determined. The candidate depth value with a least cost is selected to produce an optimal depth value for the pixel. Then, the virtual image is synthesized based on the optimal depth value of each pixel and the texture images.

### RELATED APPLICATION

This is a Continuation-in-Part Application of U.S. application Ser. No. 13/026,750, “Method for Generating Virtual images of Scenes Using Trellis Structures,” filed Feb. 14, 2011, by Tian et al.

### FIELD OF THE INVENTION

This invention relates generally to depth image based rendering (DIBR), and more particularly to a method for generating virtual images for virtual views using a trellis structure.

### BACKGROUND OF THE INVENTION

A 3D display presents an image of a different view of a 3D scene for each eye. In conventional stereo systems, images for left and right views are acquired, encoded, and either stored or transmitted, before decoded and displayed. In more advanced systems, a virtual image with a different viewpoint than the existing input views can be synthesized to enable enhanced 3D features, e.g., adjustment of perceived depth for a stereo display, and generation. of a large number of virtual images for novel virtual views of the scene to support multiview autostereoscopic displays.

Depth image based rendering (DIBR) is a method for synthesizing the virtual images, which typically requires depth images of the scene. Depth images are likely to include noise, which can produce artifacts in the rendered images, and pixel-level depth images cannot always represent depth discontinuities that typically occur at object boundaries, which is another source of artifacts in the rendered images.

As shown in FIG. 1 prior art view synthesis includes a warping step 110, in which pixels corresponding to virtual positions are warped from reference input images 101-102, i.e., texture and depth images for reference images, based on a geometry of the scene to warped images. In the texture images, each pixel (sample) has a 2D location and intensity, which can be a color if three (RGB) channels are used. In the depth images, each pixel at a 2D location is a depth from the camera to the scene.

During blending 120, the warped images, for each input viewpoint, are combined into a single image. Hole filling 130 fills any remaining holes in the blended images to produce a synthesized virtual image 103. The blending is only performed when there are multiple input viewpoints from which the synthesized virtual image is generated.

The warping step can include forward warping and backward warping. With forward warping, the pixel values in the reference image are mapped to a virtual image via a 3D projection. However, with backward warping, the pixel values in the reference images are not directly mapped to the virtual image. Instead, the depth values are mapped to the virtual image, and the warped depth image is then used to determine a corresponding pixel value in the reference image for each pixel location in the virtual image.

Most of the pixels in the virtual image are mapped after the warping process. However, some pixels do not have any corresponding mapped depth values, which are caused by disocclusion from one viewpoint to another. The pixels without mapped depth values are known as holes in the virtual image.

When there are multiple input reference images, the blending is used to merge the warping results into a single image. Some holes can be filled in a complementary way during this step. That is, a hole in the left reference image can have a mapped value from the right reference image. In addition, the blending can also resolve mapping conflicts, which arise when there are different mapped values from different reference images. For example, a weighted average can be applied, or one of the mapping values is selected depending on the proximity of the virtual viewpoint location relative to the reference images.

Following the blending process, some holes remain. Hence, final hole filling is required. For example, in-painting can be used to propagate surrounding pixel values into the remaining holes. One implementation propagates the background pixels into small holes.

Prior art methods cannot deal with errors in the depth map images. Therefore, there is a need for a more accurate view synthesis to improve a quality of the synthesized image so that the synthesized image is free of boundary artifacts, and is geometrically consistent with the image characteristics that are present in the input images.

### SUMMARY OF THE INVENTION

View synthesis is an essential function for a number of 3D video applications, including free-viewpoint navigation, and image generation for auto-stereoscopic displays. Depth image based rendering (DIBR) methods are typically applied for this purpose.

However, a quality of the rendered images is very sensitive to the quality of the depth image, which is typically estimated by an error prone process. Furthermore, per-pixel depth images are not an ideal representation of a 3D scene, especially along depth boundaries. That representation can lead to unnatural synthesis results for scenes with occluded regions.

The embodiments of the invention provide a trellis-based view synthesis method that overcomes the above limitations in depth images and can reduce artifacts in the rendered images. With this method, a candidate set of depth values are identified for each pixel that needs to be warped, based on an estimated depth value for that pixel, as well as neighboring depth values. The cost for each candidate depth value is quantified based on an estimate of the synthesis quality. Then, then the candidate depth value with the optimal expected quality is selected.

### BRIEF DESCRIPTION OF THE DRAWINGS

FIG. 1 is a block diagram of a prior art view synthesis method;

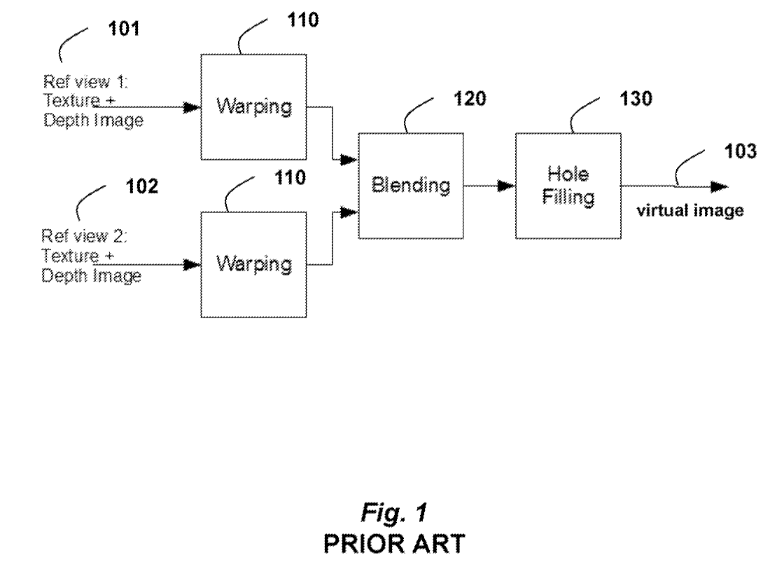

FIG. 2 is a schematic of a trellis for view synthesis constructed according to embodiments of the invention;

FIG. 3 is a schematic of neighboring pixels used to predict depth value for a next pixel according to embodiments of the invention;

FIG. 4 is another schematic of neighboring pixels used to predict the depth value for a next pixel according to embodiments of the invention;

FIG. 5 is another schematic of neighboring pixels used to predict the depth value for the next pixel according to embodiments of the invention;

FIG. 6 is a schematic of increasing and decreasing depth boundary assigned different cost functions according to embodiments of the invention;

FIG. 7 is a flowchart of a method for trellis based view synthesis according to embodiments of the invention;

FIG. 8 is a flowchart of a non-iterative method for trellis based view synthesis according to embodiments of the invention;

FIG. 9 is a flowchart of an iterative method for trellis based view synthesis according to embodiments of the invention;

FIG. 10 is a block diagram of a system including dense depth estimation, sparse depth estimation and trellis based view synthesis according to embodiments of the invention; and

FIG. 11 is a block diagram of trellis based view synthesis based on dense depth images and sparse depth features according to embodiments of the invention.

### DETAILED DESCRIPTION OF THE PREFERRED EMBODIMENT

Depth images are likely to have errors produced by an estimation or acquisition process. Additionally, the representation of per-pixel depth images is not always accurate at depth discontinuities.

Therefore, the embodiments of our invention provide a trellis-based view synthesis method to overcome limitations in depth image representation and estimation. The depth images can be acquired by range cameras, or estimated from stereo disparity correspondences in left and right texture images. Our method is applied during a warping process of depth image based rendering (DIBR).

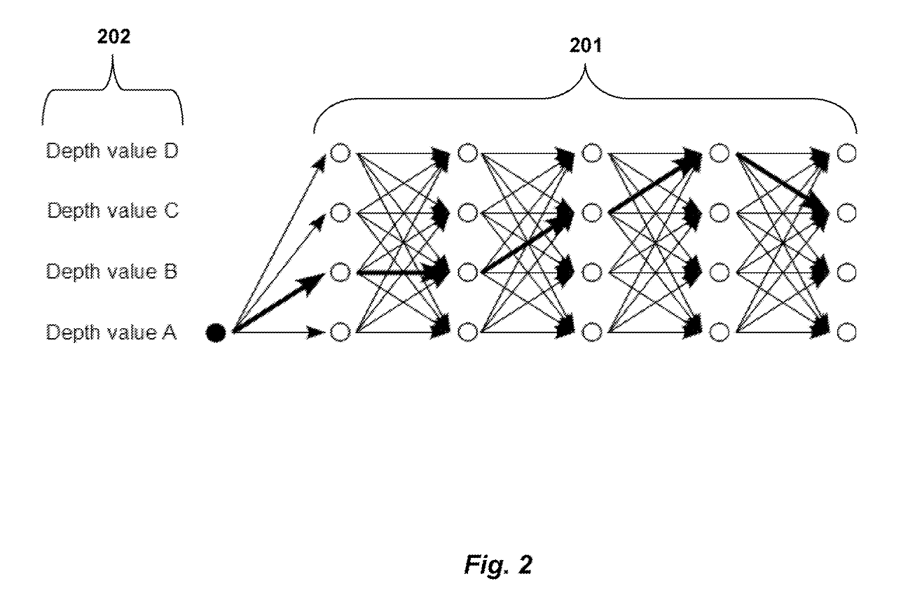

FIG. 2 shows an example of a trellis 201 constructed for view synthesis according to embodiments of our invention. The trellis 201 is constructed for a predetermined number of pixels. In one embodiment, one line of image pixels are arranged into the trellis, and the warping process is performed line-by-line. That is, each column of the trellis represents one image pixel with different depth values A-D. The nodes in each column of the trellis represent the candidate depth value mappings for that pixel in a virtual image.

In a first step, a set of depth values 202 is identified for each pixel. The set includes the estimated depth value from the input depth image, as well as several other candidate depth values based on neighboring depth values. The number of candidate depth values corresponds to the number of rows in the trellis. In FIG. 2, each pixel has four depth values A-D corresponding to the four rows in the trellis.

In a second step, a cost function is used to estimate a synthesis quality, which is the criterion to select the optimal candidate depth value.

### Determining the Set of Candidate Depth Values

In the first step, a set of candidate depth values are identified, including the estimated depth value from the input depth image. In addition to this value, several other candidate depth values are identified from the neighboring depth values. The candidate depth values can be used when the estimated depth value from the input depth image is incorrect, i.e., the depth value leads to artifacts, or inconsistencies with the input images. Several methods are described below to determine the optimal candidate depth values.

One method to determine the set of candidate depth values is with a predetermined increase and/or decrease relative to an estimated value from the input depth image. For instance, if the estimate depth value is 50, then the candidate set of depth values can include {49, 50, 51}. Increments by factors other than one can also be considered. The number of values can also be variable and not necessarily symmetric around the estimated depth value, e.g., the set can be {46, 48, 50, 52, 54} or {48, 49, 50, 52, 54}. The candidate depth values can also be determined by a look-up table, in which the candidate depth values can possibly vary for each estimated depth value.

A second method to determine the set of candidate depth values is with a predicted value based on the depth values from neighboring pixels. For example, the average or median value from neighboring depth values can be used. A predetermined window size can also be used to determine the number of neighboring pixels to consider in the prediction.

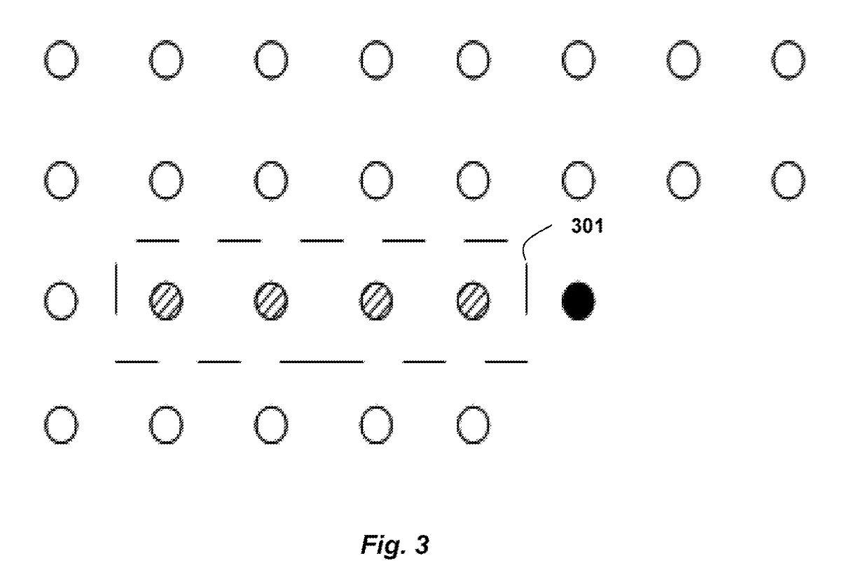

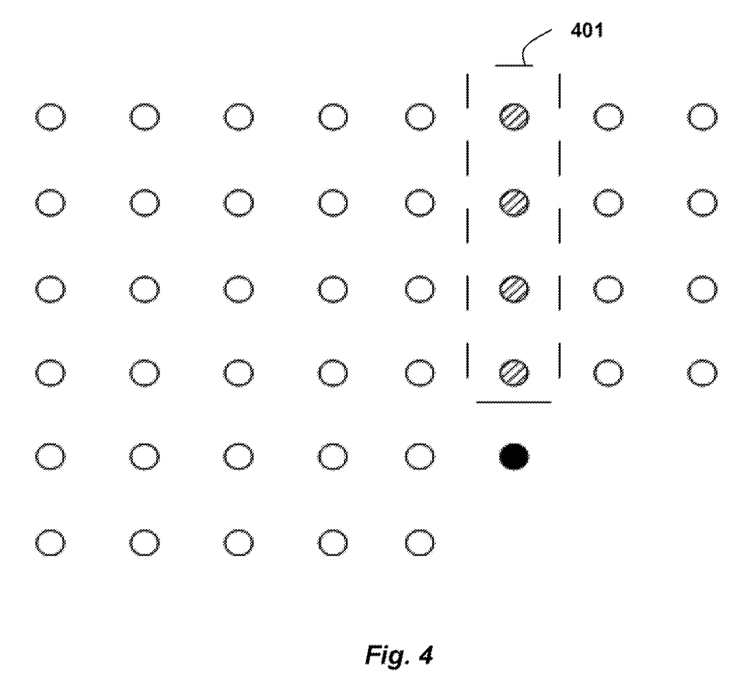

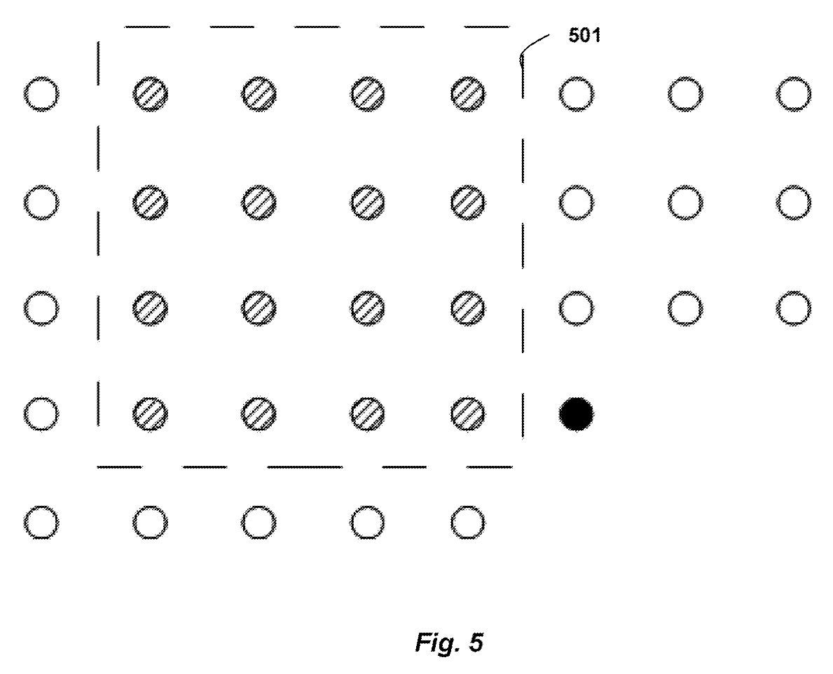

A preferred method includes the preceding pixels in a window from the same line. In FIG. 3, four (4) pixels 301 in the same line from the left are within the window. In FIG. 4, four (4) pixels 401 in the same column from above lines are within the window. In FIG. 5, a 4×4 window of pixels 501 is identified. In another implementation, the pixels can conform to any shape. An increase in the number of candidate depth values results in an increase in the computational complexity because each candidate is checked and compared.

In FIG. 2, the number of candidate depth values is set to 4 for each pixel. In one example, depth value A (the first row from the bottom) represents the estimated depth value from the input depth image. Depth value B and C (row 2 and 3 in the middle) are the depth values increased or decreased by 1 from depth value A, respectively. Depth value D (top row) indicates the predicted depth value by using the median depth value from the neighboring pixels as shown in FIG. 3.

### View Synthesis Using Dynamic Programming

After a set of candidate depth values is determined, each node in the trellis is assigned a metric according to a cost function, which estimates the synthesis quality. Then, the view synthesis problem is solved by determining an optimal set of depth values across the trellis. We use dynamic programming to solve the optimization problem.

To estimate the synthesis quality, an evaluation function is defined as the cost function. The cost function can depend on whether the warping process is forward warping, or backward warping. Without loss of generality, we describe the definition of the cost function assuming backward warping for the preferred embodiments this invention. This definition is easily applied to forward warping as well.

In one implementation, the cost function evaluates a mean square error (MSE) between two square blocks of pixels. The blocks are upper-left blocks relative to the pixel location. Let (x, y) denote the current pixel location, (x′, y′) denote the warped position using a candidate depth value.

The first block is located at (x-s, y-s)-(x, y) in the synthesized virtual image, where s is the block size, and the second block is located at (x′-s, y′-s)-(x′, y′) in the reference image. Cropping is applied if part of the block goes beyond the image area.

An energy function, other than MSE, can also be used as the cost function. For instance, the average absolute error is an effective cost function to estimate the synthesis quality. Also, image features or a structural similarity measure can be extracted from the blocks, and a matching process can be used to determine whether the blocks are geometrically consistent.

Because any artifacts in the foreground objects are more easily perceived by human eyes, a method is needed to synthesize the foreground objects in a consistent manner. Thus, in our invention, the upper-left blocks are not always used to determine the cost metric.

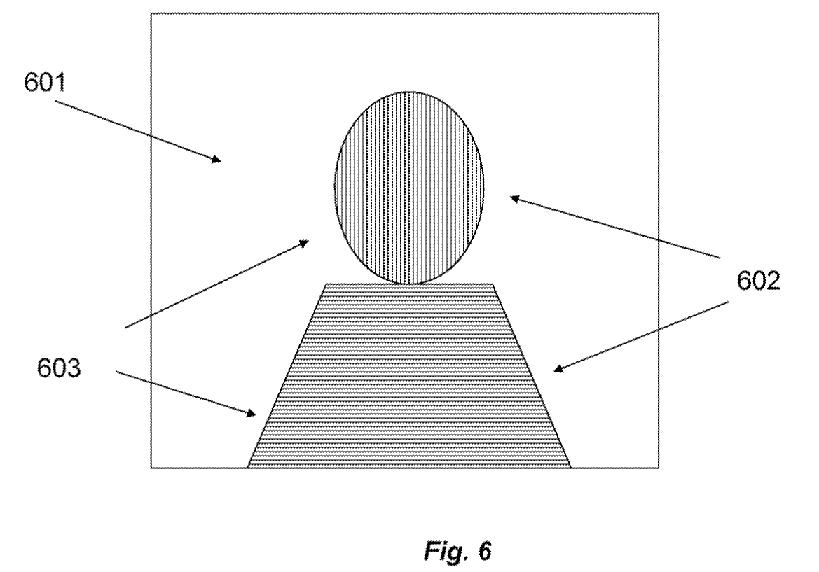

As shown in FIG. 6, a pixel is classified into three types of areas: a flat area 601, a decreasing depth area 602, and an increasing depth area 603, as shown in FIG. 6. For pixels at decreasing depth boundaries (right boundaries in FIG. 6), or flat areas, the upper-left block is used. The upper-right block is used for pixels at increasing depth boundaries (left boundaries in FIG. 6).

In some applications, a confidence map can also be used as an input to the synthesis process, in addition to the estimated depth image. The cost function for the depth value from the depth image can be weighted by a factor when the depth estimator indicates a high confidence.

### System Embodiments

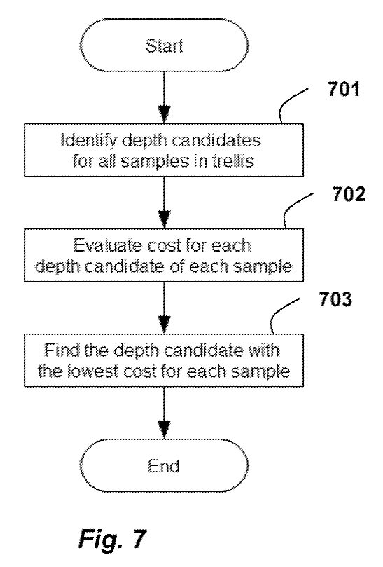

In the following, three embodiments shown in FIGS. 7-9 for the trellis-based image synthesis are described. These embodiments are ordered in ascending complexity. In the Figs. the “samples” are the pixels in the various images.

In the first embodiment as shown in FIG. 7, local optimization is performed with limited complexity. In this embodiment, candidate depth value selection does not depend on the selection of the optimal depth candidates from previous pixels. So, the candidate depth value assignment and evaluation of the pixels can be performed in parallel. A step-by-step description of this implementation is described below.

The steps shown in FIG. 7-9 can be performed in a processor connected to a memory and input/output interfaces as known in the art. The virtual image can be rendered and outputted to a display device. Alternatively, the steps can be implemented in a system using means comprising discrete electronic components in a video encoder or decoder (codec). More specifically, in the context of a video encoding and decoding system, the method described in this invention for generating virtual images could also be used to predict the images of other views. See for example U.S. Pat. No. 7,728,877, “Method and system for synthesizing multiview videos,” incorporated herein by reference.

Step 701: Identify candidate depth values for all pixels in the trellis. In this step, the following candidates are determined.
Depth value A: Select the depth value signaled in the depth image for the current pixel. If the pixel is not the first pixel in its line, then two more depth candidates are selected as follows.
Depth value B: Select the depth value that is most different from Depth value A in a set of depth values that are signaled in the depth image for a number of previous pixels of the same line. The previous pixels are as shown in FIG. 3. Four previous pixels are preferred.
Depth value C: Different from Depth value B and selected from the same line, Depth value C is selected among the depth values in the same column from the above lines, as shown in FIG. 4, which is most different from Depth value A.
Depth value D: No such candidate depth value in this embodiment.

Step 702: Evaluate the cost for each candidate depth value of each pixel.

Step 3: Compare the costs of all the candidate depth values for each pixel and determine the one with least cost. Select the corresponding depth value for each pixel.

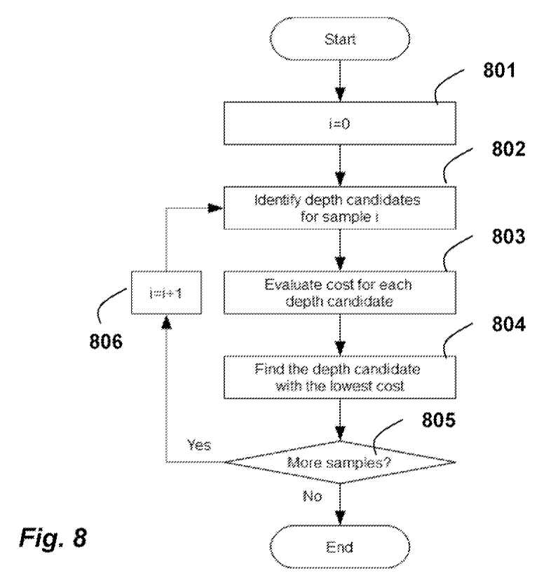

FIG. 8 shows a second embodiment, which is also a local optimization with limited complexity. In this implementation, the candidate depth value assignments in a column of the trellis depend on the optimal depth selection for the immediate previous pixel or column in the trellis. Below is a step-by-step description of this implementation.

Step 801, we initialize the index i.

Step 802: Identify candidate depth values for pixel i. In this step, we include three depth value candidates, which are selected in a similar way as the embodiment shown in FIG. 7. However, when deriving depth value B and C, the optimal depth values from previous pixels are used, which can be different from what is signaled in the depth image.

Step 803: Evaluate the cost for each depth value candidate of pixel i.

Step 804: Compare the costs of all the depth candidates and determine the least cost for pixel i.

Step 805: If there are more pixels not processed in the trellis, then increase i 806 by one and iterate.

In the first two embodiments, the optimal depth candidate is selected column by column in the trellis by evaluating a local cost function. In the third embodiment, the optimal path across the trellis, which is a combination of depth candidates from the columns, is determined. A path cost is defined as the sum of the node costs within the path.

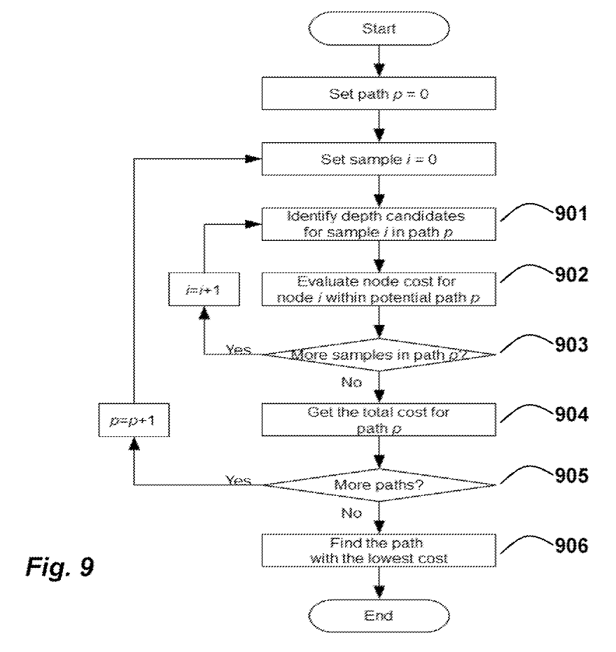

A node can exhibit different cost values within different paths, for different depth values can be assigned for a node in different paths. This embodiment is shown in FIG. 9. The procedure is composed of two loops iterating over i and p. The outer loop is over all possible paths, while the inner loop is for all nodes in a possible path.

For each potential path, we identify 901 and evaluate 902 the candidate depth value for the nodes sequentially in the path. The depth candidate assignments are determined as follows. Determine 903 if there are more pixels in the path.

If the next node locates at row “Depth value A”, then the node is set to the depth value as signaled in the depth image. If the node locates at row “Depth value B”, then we select the depth value, which is the median value from a set of given depth values of previous pixels in the same line. The given depth values of the previous pixels are specified for the current path. If the node locates at row “Depth value C”, the node is selected as the median value of those depth values from the same column of above lines in the image.

The Depth value B can be assigned different values for a same node when it is crossed by different paths. Depth Value A and C are kept the same for different paths.

After all the nodes in a path are evaluated, the path cost is determined 904 as the total of the node costs, and if no more paths 905, the path with the minimum cost is used 906 for the final synthesis result.

### View Synthesis with Sparse Depth

In our related application Ser. No. 13/026,750, we use a depth image as input to the view synthesis process, where the estimated depth value is considered one of several candidate depth values in the trellis based view synthesis process. In this way, each pixel in the input images is associated with a corresponding depth value to form a depth image. These depth images are referred to as dense depth images.

In contrast, sparse depth features refer to a collection of depth values that are associated with a small subset of pixels in the input texture images. A number of known techniques could be used to determine sparse depth values including the well-known Kanade-Lucas-Tomasi (KLT) feature tracker, which first detects corner points or salient features of an image, e.g., the left view, then finds a corresponding feature in another image, e.g., the right view.

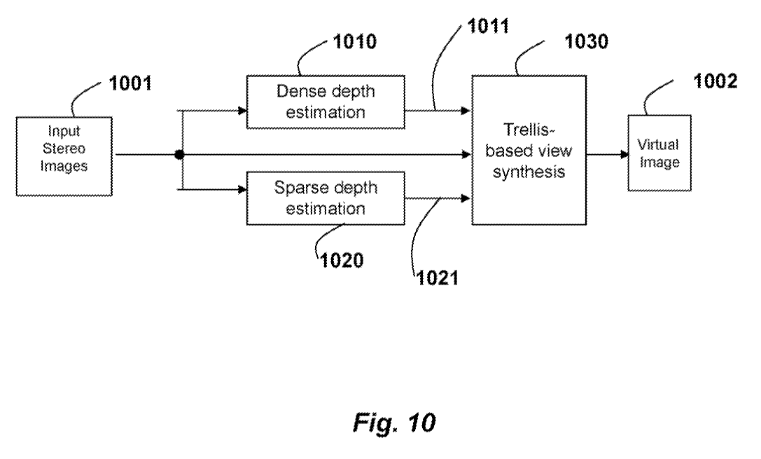

As shown in FIG. 10, dense depth estimation 1010 is performed from input stereo video images (video) 1001 to produce dense depth images 1011 corresponding to the left and right views of the stereo pair. Similarly, sparse depth estimation 1020 is performed from the input stereo video to produce a set of sparse depth features 1021, based on correspondences in the left and right views of the stereo pairs.

Then, a trellis based view synthesis is performed as described above with reference to FIGS. 7-9, using the dense depth images, the sparse depth features and the input stereo video to produce a virtual image 1002.

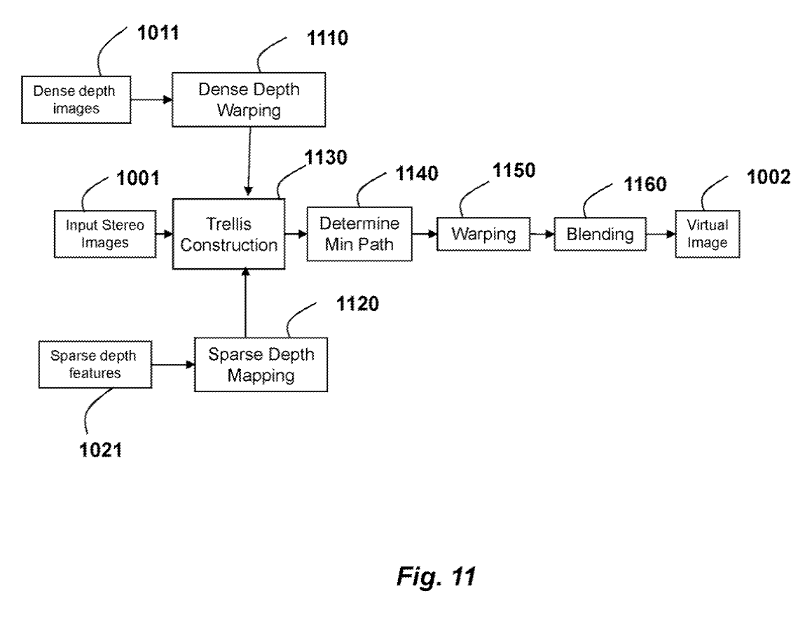

As shown in FIG. 11, the dense depth images 101 Tare subject to a dense depth warping 1110, which generates warped dense depth images that correspond to the position of the virtual view. The warping is achieved by mapping each depth value to the corresponding depth value in the virtual view according to the virtual view position and parameters of the scene geometry.

In a preferred embodiment of the invention, there are two warped dense depth images: one corresponding to the warping of the dense depth image of the left view, and another corresponding to the warping of the dense depth image of the right view. The depth values of the warped dense depth images are candidate depth values for the trellis based view synthesis.

Furthermore, the sparse depth features 1021 are subject to a sparse depth mapping process, which first generates warped sparse depth features within the virtual view. The warping of sparse depth features is similar to the warping of dense depth images, but is done on a smaller subset of features relative to the full set of pixel positions in the input images. Then, a dense set of depth values are determined from the set of warped sparse features using known prior art techniques such as nearest neighbor assignment, linear interpolation, bi-cubic interpolation, etc. Alternatively, the interpolation can be first performed on the sparse depth features and then mapped to the virtual view. The output of the sparse depth mapping process produces additional candidate depth values for the trellis based view synthesis.

As shown in FIG. 2, multiple candidate depth values could be evaluated for the view synthesis of each pixel in the virtual view. In a preferred embodiment of the invention, the candidate depth values are determined from dense depth images and sparse depth features.

The trellis construction step in FIG. 11 generates a trellis as shown in FIG. 2, where each column corresponds to one pixel position in the virtual view and each node in one column corresponds to one candidate depth value to be used for synthesis.

The trellis is constricted for one row of the virtual view image. Each node is associated with one candidate depth value and an estimated synthesis quality metric using the disparity candidate. All methods described earlier to generate candidate depth values could be used. Additionally, candidate depth values determined from the sparse depth features could be used in creating the trellis.

After the trellis is constructed, a minimum cost path through the trellis is determined 1140 in accordance with the embodiments described for FIGS. 7-9. The resulting set of depth values are used to warp 1150 the input images to the virtual view position. This process is done for both left and right input views.

Finally, a blending step 1160 is invoked in which the warped views from the left and right views are averaged by weighting factors determined by their distance from the reference views. If the virtual view position is nearer to the left view, the warped view from left view has a larger weighting factor than that from the right view. A hole-pixel in one warped view is filled using the other warped view if it is not a hole in the other warped view. After blending, the final virtual view image is displayed.

Although the invention has been described by way of examples of preferred embodiments, it is to be understood that various other adaptations and modifications can be made within the spirit and scope of the invention. Therefore, it is the object of the appended claims to cover all such variations and modifications as come within the true spirit and scope of the invention.

We claim:

1. A method for generating an image for a virtual view of a scene based on a set of texture images and a corresponding set of depth images acquired of the scene, wherein the depth images represent dense depth values, comprising the steps of:
determining sparse depth values from the texture images;
determining, using the dense and sparse depth values, a set of candidate depth values associated with each pixel of a selected image;
determining, for each candidate depth value, a cost that estimates a synthesis quality of the virtual image;
selecting the candidate depth value with a least cost to produce an optimal depth value for the pixel; and
synthesizing the virtual image based on the optimal depth value of each pixel and the texture images, wherein the steps are performed in a processor.

2. The method of claim 1, wherein the sparse depth values are determined from a set of sparse depth features.

3. The method of claim 2, wherein the sparse depth features are determined for a small subset of pixels in the texture images.

4. The method of claim 2, wherein the sparse depth features are determined using a Kanade-Lucas-Tomasi (KLT) feature tracker.

4. The method of claim 2, wherein the sparse depth features are estimated from a stereo pair of the texture images including a right view and a left view.

5. The method of claim 1, further comprising:
warping the dense depth values and sparse depth features to a virtual view.

6. The method of claim 5, wherein the warping maps each depth value to a corresponding depth value in the virtual view according to a virtual view position and parameters of a scene geometry.

7. The method of claim 1, wherein the sparse depth values are determined from the warped sparse features using a nearest neighbor assignment.

8. The method of claim 1, wherein the Sparse depth values are determined from the warped sparse features using linear interpolation.

9. The method of claim 1, wherein the sparse depth values are determined from the warped sparse features using bi-cubic interpolation.

10. The method of claim I, wherein the candidate depth values form a trellis, where each column in the trellis corresponds to one pixel position in a virtual view and each node in one column corresponds to one candidate depth value.

11. The method of claim 10, wherein a minimum cost path through the trellis is determined.

12. The method 11, further comprising:
blending the right view and the left view according to the minimum cost path.

13. A method for generating an image for a virtual view of a scene based on a set of texture images and a corresponding set of depth images acquired of the scene, wherein the depth images represent both dense and sparse depth values, comprising the steps of:
determining, using the dense and sparse depth values, a set of candidate depth values associated with each pixel of a selected image;
determining, for each candidate depth value, a cost that estimates a synthesis quality of the virtual image;
selecting the candidate depth value with a least cost to produce an optimal depth value for the pixel; and
synthesizing the virtual image based on the optimal depth value of each pixel and the texture images, wherein the steps are performed in a processor.
